(19) United States
(12) Patent Application Publication
(10) Pub. No.: US 2010/0075633 A1
(43) Pub. Date: Mar. 25, 2010

(54) Method and System for the Reading of Data from a Memory in a Mobile Remote Appliance

(75) Inventors: Matthias Lydike, Berlin (DE); Bernd Hoeppener, Berlin (DE)

Correspondence Address: LERNER GREENBERG STEMER LLP, P O BOX 2480, HOLLYWOOD, FL, 33022-2480, US

(73) Assignee: EFKON GERMANY GMBH, Berlin (DE)

(21) Appl. No.: 12/517,162

(22) PCT Filed: Nov. 23, 2007
(86) PCT No.: PCT/EP2007/010161

§ 371 Date: Jun. 1, 2009

(30) Foreign Application Priority Data
Dec. 1, 2006 (AT) A 2001/2006
May 23, 2007 (AT) A 818/2007

(51) Int. Cl. H04W 12/06; H04L 9/00

(52) U.S. Cl. 455/411; 726/3

(57) ABSTRACT

Data are read out from a memory of a mobile remote device, for example a vehicular device, by a server. A wireless connection is established between the server and the device by the server. Subsequently, an authentication check is carried out on the server side and a VPN (virtual private network) is established from the server. The data are read out from the memory of the device to the server by way of the VPN network and stored.

The invention relates to a method for the reading of data from a memory in a mobile remote appliance, e.g. vehicle appliance, by a server, wherein the server and the appliance have a wireless communication link set up between them.

Correspondingly, the invention relates to a system for the reading of data from a memory in a mobile remote appliance, e.g. vehicle appliance, by a server, which, like the appliance, has an associated modem for wireless communication.

In respect of the communication between a mobile appliance and a server, it is well known practice in electronic toll systems or similar systems for collecting charges for communication between a vehicle appliance and a central server to involve the sending of data, namely for identifying the vehicle and for debiting or paying charges, from the vehicle appliance to the server. Furthermore, it has also become known practice to transmit other kinds of data from a mobile appliance to a central computer, cf. EP 996 105 A, for example, which involves a fixed-location read/writer receiving a transmission containing data relating to temperature etc. from a mobile appliance. U.S. Pat. No. 7,034,683 B also discloses a system for monitoring vehicles, products and people, wherein RFID tags are used, and wherein appropriate data relating to location, nature of the load etc. are transmitted to a server by means of GSM. In addition, WO 2006/004231 A1 concerns itself with the remote reading of an energy meter, in which case, when data are not received, a line connection needs to be set up to a read modem, with an authentication code being provided for this special case. Specifically, however, this involves the use of services in an available network, particularly in the case of a piece of fixed equipment, in contrast to access to individual remote, mobile, passive appliances by a central station.

On the other hand, EP 1 655 921 A1, for example, has disclosed the practice of subjecting users of a communication system to authentication for network access, so that only authorized subscriber terminals are provided with access to the network. VPN links are also known per se, for example see US 2006/0155822 A1, which quite generally discloses a VPN link between a mobile appliance and an Internet device, which involves a service network in which rights allocation and use of the service are in the foreground. The problem of reading data, particularly data which can be associated with different owners, in objects or appliances which are mobile and totally passive is not addressed here.

In practice, the situation often arises in which data need to be transmitted from a mobile, remote, passive terminal to a computer, namely a data station, at the latter's request, this data transmission needing to be able to be implemented without any special complexity on the mobile remote appliance, and secondly aspects of data protection needing to be taken into account.

It is therefore an object of the invention to provide a method and a system for the reading of data from a memory in a mobile remote appliance by a server as indicated at the outset in order to transmit data to the server, at the latter's request, easily and securely even using a public network and while observing legal data protection regulations. In particular, the aim in this context is to allow download of authentic data when the object or appliance containing the data is too far away for it to be able to be reached directly, or else is continually changing its location on the basis of the mobile design. In this case, the aim is furthermore also to allow particular data to be requested and downloaded from different appliances, particularly also on behalf of authorized companies.

The invention achieves this object by providing a method or a system for the reading of data as presented in the independent claims. Advantageous embodiments and developments are specified in the dependent claims.

The inventive technology allows a data station, a server, which may be not only fixed but also mobile, for example, to request and download data from a mobile remote (vehicle) appliance, this being able to be done using a conventional radio link, particularly using GPRS or GSM, or else an infrared (IR) link, a Wireless-LAN link or a similar wireless link for example. Specifically, when such a communication link has been set up from the server, a VPN (Virtual Private Network) link is produced between the server and the appliance, and the relevant applications on the server and on the remote appliance are incorporated into the link. The authentication process is used to ensure that the desired data can be downloaded only with appropriate authorization, this data transmission preferably also being effected with encryption for security reasons. This allows different companies to request desired data from the widest variety of appliances and download them to the server, and the server (or one of a plurality of servers operating in the network) can also be made available to various customers for such download services. It is thus conceivable, for example, for vehicle-specific data, such as tachograph data, to be downloaded, i.e. for such objects to be “read remotely”, from vehicles. The data to be transmitted may therefore be personal, for example driver-related, data or other specific data which need to be protected from the point of view of legal data protection and which may respectively be made accessible only to an authorized company; furthermore, protection against manipulation is advantageous for the data during transport via a public network. This is achieved by the inventive measures with the VPN communication path in a public network and by the authentication and possibly by the encryption, with key interchange, for a protected link. Preferably, the authentication is performed using an authentication card which is read in a card reader—following presentation by a customer of the server, for example—so as to obtain access authorization for particular mobile appliances, for example appliances in particular vehicles, in the field. Alternatively, it is possible to connect the authentication unit to a management unit for virtual card images (electronic “authorization cards”). Beyond this, no additional measures are required. The telephone numbers of the appliances in the case of mobile telephone connections may by all means be public, and the access authorization for the data is provided in line with the invention, as mentioned, by means of the authentication, particularly by means of an authentication card.

The invention therefore allows the secure reading of data from a memory in a mobile remote appliance which is a passive appliance, all the necessary steps for reading the data being performed by the server or computer, that is to say the “data station”. In this case, the server-end authentication ensures that only admissible access operations for data in the mobile, passive appliances can take place, and in the case of data from different owners, the authentication also ensures that only one's own data are accessed. In contrast to known data reading techniques, there is no compulsory service connection and no network connection, and signed data, worthy of protection, in a passive, mobile object can be accessed securely, from the central data station. In this context, the—inherently known—VPN link is also relevant.

The invention is explained in more detail below using preferred exemplary embodiments, which are not intended to limit it, however, and with reference to the drawing, in which, specifically:

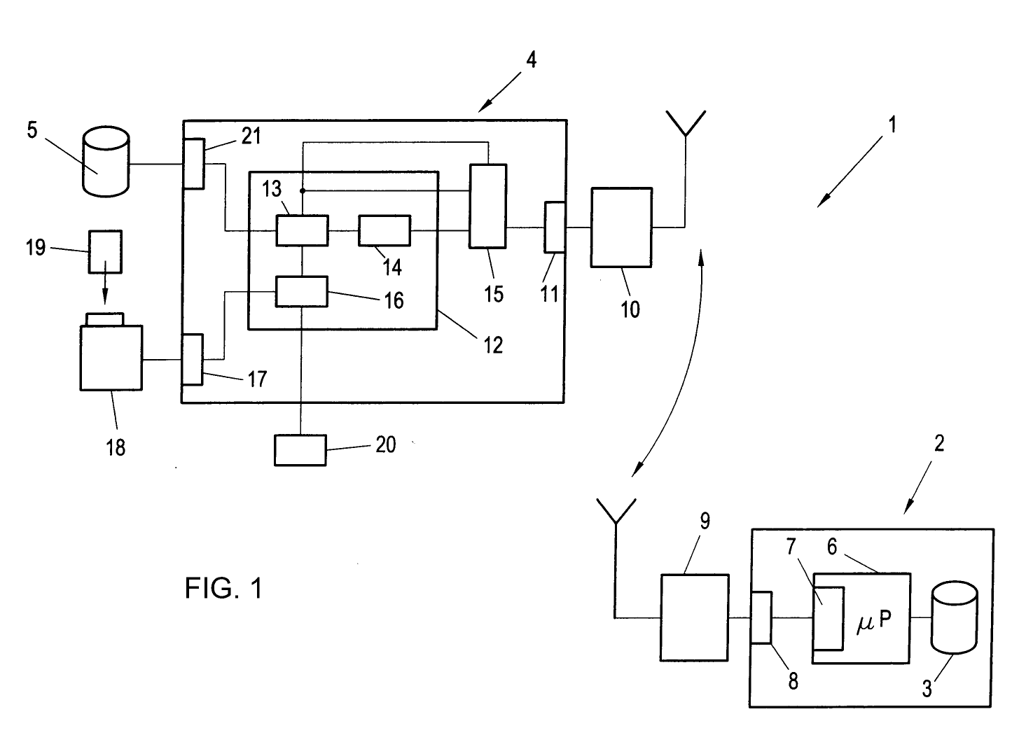

FIG. 1 schematically shows a block diagram of an inventive system for the remote reading of data with a server and mobile appliance;

FIG. 1A schematically shows a comparable block diagram of an inventive system for the remote reading of data which has been modified in comparison with FIG. 1;

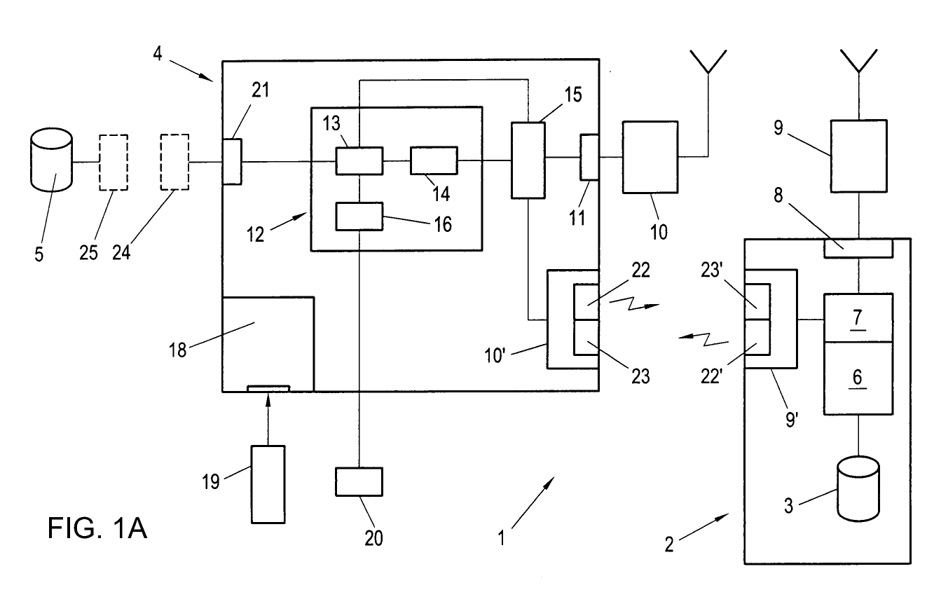

FIG. 2 schematically shows the connection setup between server and appliance with the setup of a VPN link and with the provision of an authentication and encryption procedure;

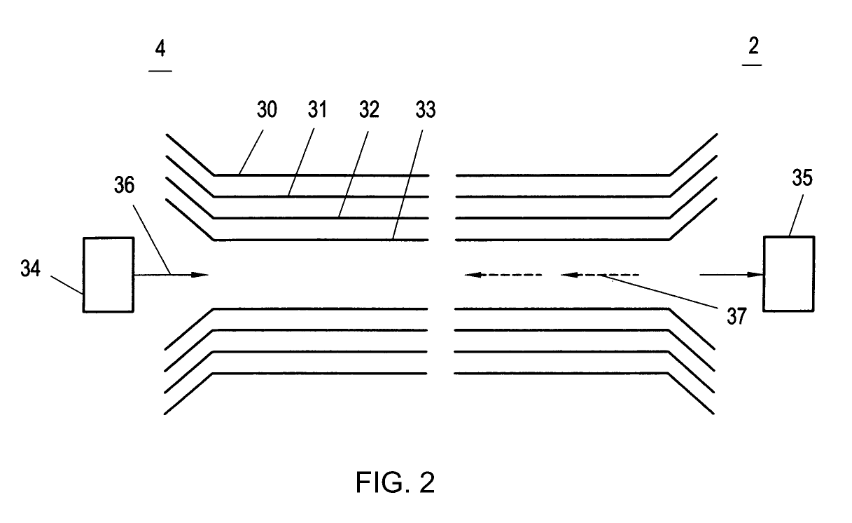

FIG. 3 shows a flowchart to illustrate the fundamental procedure in the inventive method for the remote reading of data; and

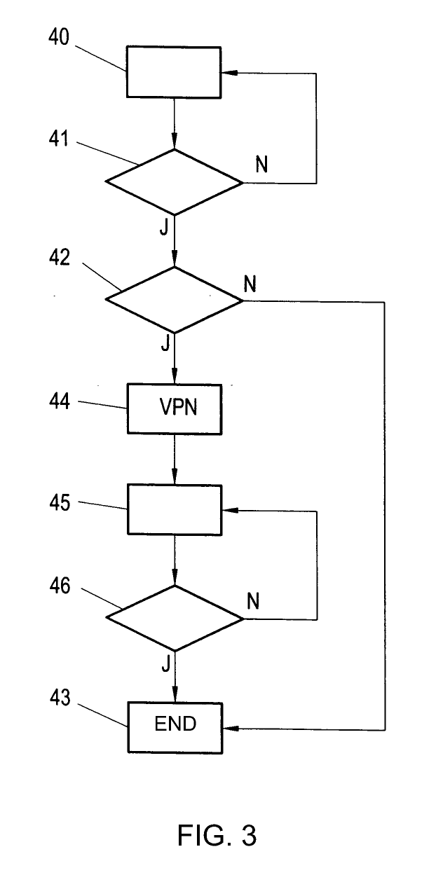

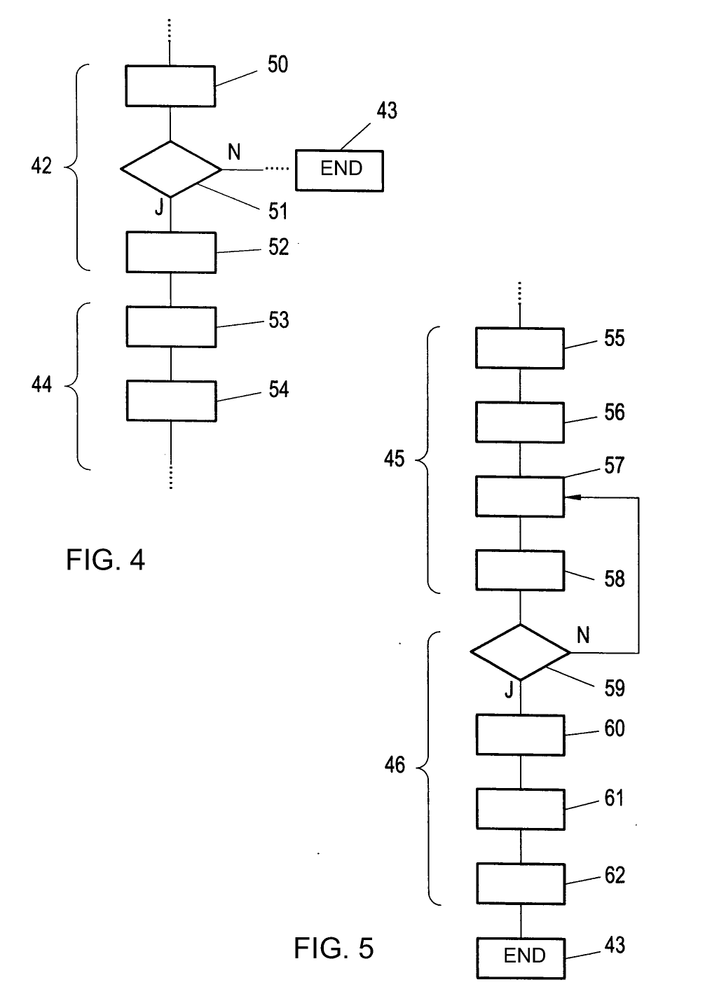

FIGS. 4 and 5 show detailed flow charts for sections in the flow chart shown in FIG. 3, to illustrate the authentication procedure and the data transmission.

FIG. 1 schematically shows a system 1 for the reading of data from a passive remove appliance 2, which may be a mobile appliance, namely particularly a vehicle appliance, such as what is known as an OBU (On Board Unit), or else may be another appliance, such as an appliance connected to a tachograph in the case of heavy goods vehicles. From this appliance 2, i.e. to be more precise from a memory 3 in this appliance 2, a data station, subsequently server 4 for short, requests the respective data in order to receive a transmission containing them while security precautions are observed, as will be explained in more detail below. In this case, it should be self-evident that the one server 4 shown is to be understood merely as an example and that there may also be a plurality of servers in the network, possibly connected to a shared database 5, as memories in which the downloaded data are stored, and that, in particular, there may also be a multiplicity of appliances 2, for example several thousand appliances 2.

The memory 3 in the respective appliance 2 may be in the widest variety of known embodiments, and the data are written to this memory 3 or read from the memory 3 using a processor 6 or similar computer means. The processor 6 (subsequently called μP 6 for the sake of simplicity) has an associated encryption/decryption unit 7 which may be in the form of a dedicated component and may be connected to the μP 6, but which may also be in the form of a software module in a program store in the μP 6. In addition, the μP 6 also contains an appropriate communication module (not illustrated in more detail) in order to use an interface 8 and a modem 9 for wireless communication which is connected thereto, such as a GPRS modem or a Wireless-LAN modem (W-LAN modem), to communicate with the server 4.

The respective connection setup via these wireless communication paths is effected from the server 4, which has an appropriate communication modem 10, e.g. a GPRS modem or a Wireless-LAN modem, associated with it, to which it is connected by means of an interface 11. The server 4 contains computer means 12 which may be formed by one or more processors or microcomputers (μC), a portion thereof forming a dedicated control unit 13 which has an associated encryption/decryption unit 14 and is connected to the modem 10 by means of a VPN device 15 and the interface 11.

In addition, the computer means 12 contain an authentication unit 16 which is connected by means of an interface 17 to a card reader 18 for reading authorization cards 19 which contain a code and which are inserted into the card reader 18. If appropriate, the unit 18 provided may also be a management unit for virtual authorization cards (virtual card images). In addition, an input unit 20 is provided, with an appropriate authentication procedure likewise being conceivable in this case in order to demonstrate access authorization for requesting data from the respective appliance 2. The control unit 13 in the computer means 12 is also connected to the memory 5 by means of an interface 21.

FIG. 1A illustrates a system 1 for reading data from a remote, mobile appliance 2, for example again an OBU vehicle appliance, said system 1 being modified in comparison with the system shown in FIG. 1. In this case too, the system 1 has a server 4 for requesting data from the remote appliance 2, specifically from the memory 3 thereof. In this case, the server 4 is preferably in the form of a mobile reading apparatus and is, in principle, of similar design to the server 4 shown in FIG. 1, which means that, where there is a match, there is no need for another detailed description, in similar fashion to in the case of the appliance 2. At any rate, corresponding components of the server 4 as well as of the remote appliance 2 have been provided with the same reference numerals.

In particular, the server 4 shown in FIG. 1A again has computer means 12 with a control unit 13, an encryption/decryption unit 14 and an authentication unit 16. Unlike in the case of FIG. 1, the system 1 shown in FIG. 1A has the card reader 18 integrated in the server 4 in order to allow authorization cards 19 to be inserted directly into the server 4 and read thereby.

In a similar manner to in FIG. 1, the system 1 shown in FIG. 1A also has a VPN device 15 connected to the computer means 13, with a mobile telephone modem, e.g. a GSM modem or a W-LAN modem, generally a modem 10, being connected to the VPN device 15 by means of an interface 11.

In addition, FIG. 1A now also shows an inherently known modem 10′ for infrared communication connected to the VPN device 15. By way of example, this IR modem 10′ contains IR transmission means 22, for example in the form of appropriate LEDs, and also IR receiver means 23, for example in the form of one or more IR-sensitive diodes.

Correspondingly, the remote appliance 2 also has an IR modem 9′ with IR transmission means 22′ and IR reception means 23′, this IR modem 9′ being connected to the processor 6 of the appliance 2 via the encryption/decryption unit 7. This IR modem 9′ may be provided instead of the radio modem, W-LAN modem or mobile telephone modem 9 shown in FIG. 1 or else preferably, as shown in FIG. 1A, in addition to the latter modem 9, so as to provide for the reading of data at the request of the server 4 either via the W-LAN or mobile telephone link (modems 9, 10) or via the infrared communication link (modems 9′, 10′), according to choice or on the basis of more favorable communication conditions.

In the case of a mobile server 4, it is also expedient to set up the connection between this server 4 and the database 5 via a wireless network (radio network) if the database 5 is not integrated in the server 4. Accordingly, FIG. 1A also uses dashed lines to illustrate, by way of example, an arrangement of transmission and reception radio modems 24 and 25 for the communication between the mobile server 4 and the database 5.

FIG. 2 schematically shows a quite schematic illustration of the connection between the server 4 and the appliance 2 with the plurality of security levels provided. In this case, the first measure (outer shell) illustrated is the setup of a communication link 30, and the next “skin” inward that is illustrated is the setup of a VPN link 31. The additional security measures illustrated on the next highest level are the described authentication 32 and also the encryption 33 during the transmission of the data between the respective applications 34, 35 on the server 4 and on the appliance 2. In this case, specifically, 36 additionally indicates the data request and the authentication process and the transfer of the keys and 37 indicates the transmission of the data.

The following is now intended to provide a more detailed explanation of an actual operation during the data transmission with reference to FIGS. 3 to 5, which illustrates flowcharts to illustrate the procedure during the remote reading of the data, as already described above. In this case, FIG. 3 generally shows that, in a box 40 at the start, when there is a request for data transmission, a wireless link is set up to the appliance 2 from the server 4. A test box 41 then checks whether this wireless link is set up via GSM or GPRS, for example, or else via IR, and if not, the process returns to the starting box 40.

As soon as the wireless link exists, however, a further test box 42 tests whether access is authorized, i.e. whether authentication is in place or has been performed. If this is not the case, the process immediately continues to the end 43 of the operation. If the result of the check in test box 42 is that the access is authorized, however, the VPN link is set up from the server in a box 44. Subsequently, in a box 45, the data are transmitted from the appliance 2 to the server 4, with a test box 46 continually testing whether the data have already been transmitted in full. If this is not the case, the data transmission is continued in box 45. If the data have been transmitted in full, however, the end 43 of the operation has been reached.

FIG. 4 shows a more detailed illustration of the operation for the authentication, it being assumed that the security modules (crypto control) of the server 4 and of the terminal 2 respectively have special keys; the company key and the terminal (frontend) key must together result in a valid pair.

In FIG. 4, the server 4 sends the company identifier, i.e. an identification for that company for which the data transmission needs to be prompted and which is authorized to transmit the data from the respective terminal 2, in a box 50 for the purpose of authentication. A test box 51 then checks this company identifier in the appliance 2, and if the appliance 2 states a rejection, i.e. the company identifier is not known to the appliance 2, the process moves to the end 43 as described. Otherwise, the appliance 2 returns an acknowledgement message to the server 4, see box 52 in FIG. 4. The server 4 then provides a VPN key for setting up a VPN link, see box 53, after which the VPN link is set up in box 54.

As already explained, this is followed by the data transmission, which is shown in more detail in FIG. 5. To start with, the server 4 requests a list of accessible data in box 55; in this case, it should be borne in mind that a plurality of authorized subscribers are conceivable which each have associated data but which also have to be protected from one another. In box 56, the appliance 2 then sends the list of accessible data to the server 4, the server 4 then requests the data on the basis of the transmitted list, see box 57 in FIG. 5, and in box 58 the appliance 2 sends the data and the associated signature if, as preferred, the data are already stored in signed form in the memory 3 of the appliance 2. In continuation, in test box 59, the server 4 tests whether the end of the list has been reached, i.e. whether all the data as per the list have been transmitted; if not, the process returns to box 57 in order to request further data. If the data as per the list have been transmitted completely, however, the data transfer is ended in box 60, the VPN link is closed in box 61, and finally the wireless communication link (GSM, GPRS) is ended in box 62, with the end step 43 then having been reached.

1-21. (canceled)

22. A method for reading data from a memory in a mobile remote vehicle device, the method which comprises:
setting up a wireless communications link between a server and the vehicle device;
subsequently performing an authentication check from the server at a server end and setting up a VPN (Virtual Private Network) link from the server end; and
subsequently reading the data from the memory in the vehicle device, transmitting the data to the server via the VPN link, and storing the data.

23. The method according to claim 22, which comprises setting up the wireless communication link via a mobile telephone network (e.g. GPRS).

24. The method according to claim 22, which comprises setting up the wireless communication link via infrared.

25. The method according to claim 22, which comprises setting up the wireless communication link via a Wireless LAN.

26. The method according to claim 22, wherein the authentication check comprises reading a code from an authorization card.

27. The method according to claim 22, wherein the authentication prompts access authorization to be granted for the data in at least one predetermined mobile remote vehicle device but not to data in other mobile remote vehicle devices.

28. The method according to claim 22, which comprises transmitting the data in encrypted form.

29. The method according to claim 22, which comprises transmitting the data for remotely reading meters, counters, or tachographs.

30. The method according to claim 22, which comprises transmitting the data for remotely reading power supply units.

31. A system for reading data from a memory in a mobile remote vehicle device, comprising:
a server with a modem for wireless communication;
a modem for wireless communication associated with the vehicle device;
said server having a VPN device for setup of a VPN link to the modem associated with the vehicle device following setup of a wireless communication link by the server; and
said server having an associated authentication unit.

32. The system according to claim 31, wherein set VPN device is configured to set up the VPN link only if authentication is in place.

33. The system according to claim 31, wherein said modems for wireless communication are mobile telephone modems.

34. The system according to claim 31, wherein said modems for wireless communication are infrared modems.

35. The system according to claim 31, wherein said modems for wireless communication are W-LAN modems.

36. The system according to claim 31, wherein said authentication unit is connected to a card reader for reading authorization cards or to a management unit for virtual card images.

37. The system according to claim 31, wherein the vehicle device and said server have an encryption unit or decryption unit, enabling data transfer with encryption.

38. The system according to claim 31, wherein the server is a mobile server.

39. The system according to claim 31, wherein said server includes at least two modems selected from the group consisting of a mobile telephone modem, a W-LAN modem, and an IR modem for wireless communication.

40. The system according to claim 31, wherein said modem for wireless communication associated with the vehicle device is one of at least two modems selected from the group consisting of a mobile telephone modem, a W-LAN modem, and an IR modem for wireless communication.
